(19) United States
(12) Patent Application Publication
(10) Pub. No.: US 2022/0129593 A1
(43) Pub. Date: Apr. 28, 2022

(54) LIMITED INTROSPECTION FOR TRUSTED EXECUTION ENVIRONMENTS

(71) Applicant: Red Hat, Inc., Raleigh, NC (US)

(72) Inventors: Michael Tsirkin, Westford, MA (US); Michael Bursell, Great Yeldham (GB)

(21) Appl. No.: 17/082,679

(22) Filed: Oct. 28, 2020

(51) Int. Cl. G06F 21/79; G06F 21/53; G06F 21/55; G06F 21/60

(52) U.S. Cl. CPC G06F 21/79; G06F 21/53; G06F 2221/034; G06F 21/602; G06F 21/552

(57) ABSTRACT

A system includes a memory, a processor in communication with the memory, a supervisor, and a trusted execution environment (“TEE”). The TEE includes an introspection module and is configured to execute the introspection module on a workload according to an introspection security policy. Additionally, the TEE is configured to generate an introspection result for the workload. The introspection security policy specifies at least one of (i) a portion of the TEE that is exposed to the introspection module and (ii) at least one of an accelerator and a device the introspection module has access to. Additionally, the introspection module is configured to validate the workload. The introspection result is one of a passing result and a failing result.

### BACKGROUND

Trusted execution environments, such as trusted virtual machines may be used to emulate all or a portion of a computer system. The trusted execution environments allow running various software modules, for example, multiple operating systems, concurrently and in isolation from other software modules, on one or more interconnected physical computer systems. Additionally, trusted execution environments may, for example, allow for consolidating multiple physical servers into one physical server running multiple guest virtual machines in order to improve the hardware utilization rate.

Trusted execution environments may include containers, enclaves and virtual machines. Virtualization may be achieved by running a software layer, often referred to as a hypervisor, above the hardware and below the trusted execution environment, such as guest virtual machines or containers. A hypervisor may run directly on the server hardware without an operating system beneath it or as an application running on a traditional operating system. A hypervisor may virtualize the physical layer and provide interfaces between the underlying hardware and trusted execution environments. In some cases, the trusted execution environments may be encrypted for security purposes. During execution, a system owner or administrator may perform debugging or forensic analysis while monitoring the activities of trusted execution environments and associated runtimes and workloads.

### SUMMARY

The present disclosure provides new and innovative systems and methods for limited introspection trusted execution environments, such as a virtual machines (“VMs”), containers and enclaves. Additionally, the present disclosure provides systems and methods that preserve privacy when performing introspection services for trusted execution environments. In an example, a system includes a memory, a processor in communication with the memory, a supervisor, and a trusted execution environment (“TEE”). The TEE includes an introspection module and is configured to execute the introspection module on a workload according to an introspection security policy. Additionally, the TEE is configured to generate an introspection result for the workload. The introspection security policy specifies at least one of (i) a portion of the TEE that is exposed to the introspection module and (ii) at least one of an accelerator and a device the introspection module has access to. Additionally, the introspection module is configured to validate the workload. The introspection result is one of a passing result and a failing result.

In an example, a method includes provisioning a TEE with a workload. The TEE includes an introspection module. The method also includes executing the introspection module on the workload according to an introspection security policy. The introspection security policy specifies at least one of (i) a portion of the TEE that is exposed to the introspection module and (ii) an accelerator the introspection module has access to. Additionally, the method includes validating the workload and generating an introspection result for the workload. The introspection result is one of a passing result and a failing result.

In an example, a non-transitory machine-readable medium stores code, which when executed by at least one processor is configured to provision a TEE with a workload. The TEE includes an introspection module. The non-transitory machine-readable medium is also configured to execute the introspection module on the workload according to an introspection security policy. The introspection security policy specifies at least one of (i) a portion of the TEE that is exposed to the introspection module and (ii) at least one of an accelerator and a device the introspection module has access to. Additionally, the non-transitory machine-readable medium is configured to validate the workload and generate an introspection result for the workload. The introspection result is one of a passing result and a failing result.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a block diagram of an example computer system according to an example embodiment of the present disclosure.

FIG. 2 illustrates a block diagram of an example introspection system for TEE instances according to an example embodiment of the present disclosure.

FIG. 3 illustrates a flowchart of an example process for performing introspection for TEE instances according to an example embodiment of the present disclosure.

FIGS. 4A and 4B illustrate a flow diagram of an example process for performing introspection services for a TEE while preserving privacy according to an example embodiment of the present disclosure.

FIG. 5 illustrates a block diagram of an example introspection system according to an example embodiment of the present disclosure.

### DETAILED DESCRIPTION OF EXAMPLE EMBODIMENTS

Techniques are disclosed for limited introspection for TEEs. The limited introspection preserves privacy when performing introspection services for trusted execution environments, such as a virtual machines (“VMs”), containers and enclaves. Modern hardware supports trusted execution environment (TEE) techniques where a supervisor of a host computer does not have access to memory of a specific TEE, such as a trusted container, a trusted virtual machine, or a trusted software enclave running on the host computer. For example, the supervisor may lack access to the memory of the TEE because the memory is protected by host hardware or host firmware. Memory encryption is one such technique to protect the memory of the TEE. In an example, encrypted memory may be used to support and protect running sensitive workloads in the cloud.

For example, TEEs allow for private computation in a cloud environment. The private computation is private from a hypervisor or supervisor, which controls the execution of the TEE. Therefore, challenges exist regarding support for safe introspection for TEEs. One example of such an environment is Enarx where an owner supplied code (e.g., owner supplied bytecode) is loaded by a runtime (e.g., WebAssembly runtime) running within a TEE (e.g., encrypted virtual machine). Other alternative approaches include hardware that supports introspection (e.g., a special hardware backdoor), but using a backdoor for introspection generally weakens product security.

Introspection is a service for identifying or finding known bad (e.g., malicious) patterns in memory of a container or a virtual machine. For example, introspection may include techniques and processes for monitoring runtimes or runtime statistics of containers or virtual machines. Introspection services may be beneficial for debugging or forensic analysis. The introspection services typically run as part of the hypervisor or supervisor and are typically granted access to the memory of the container or virtual machine. Thus, performing introspection services involves trusting the hypervisor or supervisor. Typically, either a hardware sandbox (e.g., a non-encrypted virtual machine) or a software sandbox (e.g., a bytecode validator) may be used where the introspection is supported as part of the hardware sandbox. However, supporting introspection through the hardware sandbox, which was non-encrypted, may compromise workload security. Additionally, the security model of TEEs does not allow that level of trust (e.g., granting the hypervisor or supervisor access to the memory of the TEE) between the TEE and the hypervisor or supervisor. Specifically, the security model of TEEs, such as an Enarx encrypted virtual machine, does not allow running introspection services as part of the hypervisor or supervisor.

Typically, workloads are executed directly within a TEE that is executing on top of a hypervisor or supervisor. Introspection services typically run as part of the hypervisor or supervisor, which as noted above is incompatible with the security model of TEEs. However, to address the problems discussed above and to enable support for introspection for a TEE, the TEE owner may supply an introspection security policy that specifies which part(s) of the environment are exposed to the introspection module. The introspection security policy may also specify how the introspection module can execute analysis (e.g., access to specific accelerators) and how the introspection module can repot the analysis information. In this way, the supervisor can enforce the introspection security policy to preserve privacy, such that the TEE can allow introspection services without fully trusting the introspection process.

The introspection module validates the workload (e.g., memory accesses or events performed by the workload) by executing the introspection commands thereby advantageously enabling introspection services that would otherwise be unavailable to TEEs. For example, the introspection security policy for the introspection service advantageously allows the TEE to run the introspection service without having to trust a hypervisor or supervisor. Thus, TEEs can safely perform introspection without having to trust a hypervisor or a supervisor. Additionally, by lifting introspection capabilities to the software sandbox, introspection may be supported by TEEs without compromising workload security. Introspection is an especially important feature for cloud vendors as it adds value compared to private cloud solutions. For example, vendors using a hypervisor (e.g., Kernel-based Virtual Machine (“KVM”)) on an operating system, such as Red Hat® Enterprise Linux® (“RHEL”) may utilize the systems and methods disclosed herein to preserve privacy while performing introspection services for TEEs. When handling network traffic (e.g., network traffic from a cloud-computing platform such as the Red Hat® OpenS tack® Platform), hypervisor vendors and operating system (“OS”) vendors often attempt to improve security to prevent malicious memory accesses. An example vendor is Red Hat®, which offers RHEL. By providing introspection services limited by the introspection security policy as described herein, thereby maintaining privacy for TEEs, security may be improved.

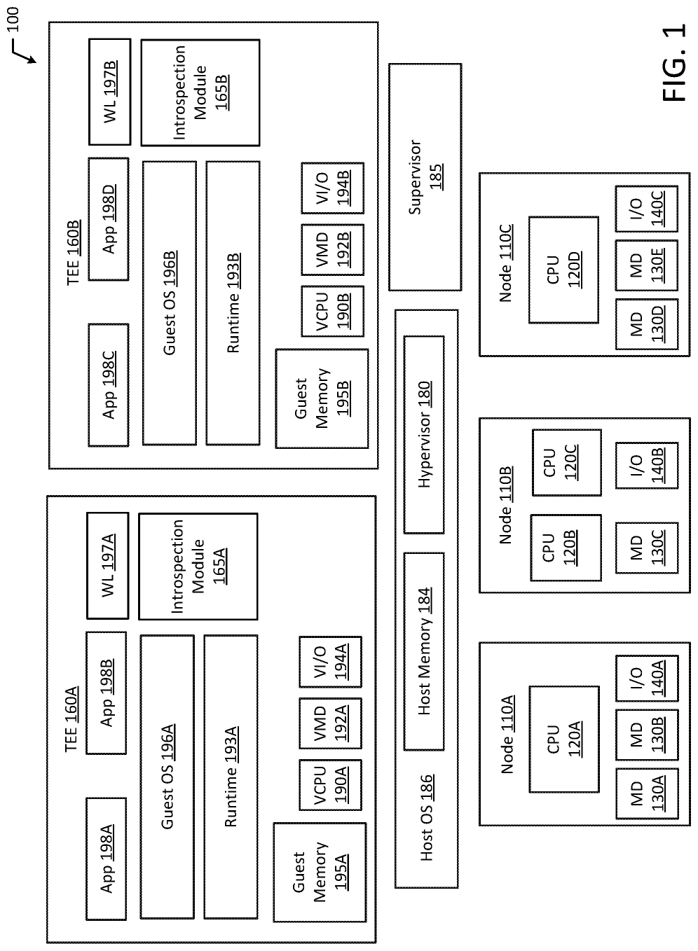

FIG. 1 depicts a high-level component diagram of an example computing system 100 in accordance with one or more aspects of the present disclosure. The computing system 100 may include a supervisor 185, an operating system (e.g., host OS 186), one or more TEEs (e.g., TEE instances 160A-B) and nodes (e.g., nodes 110A-C).

A TEE instance (e.g., TEE instance 160A) may be a virtual machine, container, enclave, etc. and may include an introspection module (e.g., introspection module 165A). The introspection module (e.g., introspection module 165A) may include introspection code that is executed in the TEE or a VM (e.g., a java virtual machine or a KVM virtual machine). Each TEE instance 160A-B may include a respective introspection module 165A-B and may execute a workload 197A-B. The TEE instance 160A-B may also include a runtime, a guest OS, guest memory, a virtual CPU (VCPU), virtual memory devices (VMD), and virtual input/output devices (VI/O). For example, TEE instance 160A may include runtime 193A, guest OS 196A, guest memory 195A, a virtual CPU 190A, a virtual memory device(s) 192A, and virtual input/output device(s) 194A. Virtual machine memory 195A may include one or more memory pages. Similarly, TEE instance 160B may include runtime 193B, guest OS 196B, guest memory 195B, a virtual CPU 190B, virtual memory device(s) 192B, and virtual input/output device(s) 194B.

The runtimes 193A-B may be a software module or environment that supports execution, such as application execution, code execution, command execution, etc. In some examples described in more detail herein, the runtimes 193A-B may validate memory accesses that occur during the application execution, code execution, command execution, etc. The runtimes 193A-B may be loaded into their respective TEEs or TEE instances 160A-B. For example, runtimes 193A-B may be loaded into TEE instances 160A-B along with a workload 197A-B and may have additional permissions of the workload owner. In an example, the runtimes 193A-B may be a software or virtual layer below the workload 197A-B or a layer sitting beside the workload 197A-B. As illustrated in FIG. 1, TEE 160A includes both a runtime 193A and an introspection module 165A, however, in some examples, the introspection module 165A may be part of a runtime 193A or may make up the entirety of the runtime 193A or vice versa. For example, a runtime 193A may be extended to include introspection capabilities (e.g., the capabilities of introspection module 165A). In some scenarios, the runtime 193A may provide similar services and functionality as Guest OS 196A.

The computing system 100 may also include a supervisor 185 or hypervisor 180 and host memory 184. The supervisor 185, which may be a hypervisor, such as hypervisor 180, may manage host memory 184 for the host operating system 186 as well as memory allocated to the TEEs (e.g., TEE instances 160A-B) and guest operating systems (e.g., guest OS 196A such as guest memory 195A provided to guest OS 196A). Host memory 184 and guest memory 195A may be divided into a plurality of memory pages that are managed by the supervisor 185 or hypervisor 180. Guest memory 195A allocated to the guest OS 196A may be mapped from host memory 184 such that when an application 198A-D uses or accesses a memory page of guest memory 195A, the guest application 198A-D is actually using or accessing host memory 184.

In an example, a TEE instance (e.g., TEE instance 160A-B), such as a virtual machine, container or enclave may execute a guest operating system 196A and run applications 198A-B which may utilize the underlying VCPU 190A, VMD 192A, and VI/O device 194A. For example, one or more applications 198A-B may be running on a TEE under the respective guest operating system 196A. TEEs (e.g., TEE instances 160A-B) may run on any type of dependent, independent, compatible, and/or incompatible applications on the underlying hardware and OS. In an example, applications (e.g., App 198A-B) run on a TEE may be dependent on the underlying hardware and/or OS 186. In another example, applications 198A-B run on a TEE may be independent of the underlying hardware and/or OS 186. For example, applications 198A-B running on a first TEE instance 160A may be dependent on the underlying hardware and/or OS 186 while applications (e.g., application 198C) running on a second TEE instance 160B are independent of the underlying hardware and/or OS 186A. Additionally, applications 198A-B running on TEE instance 160A may be compatible with the underlying hardware and/or OS 186. In an example, applications 198A-B running on a TEE instance 160A may be incompatible with the underlying hardware and/or OS 186.

The computer system 100 may include one or more nodes 110A-C. Each node 110A-C may in turn include one or more physical processors (e.g., CPU 120A-D) communicatively coupled to memory devices (e.g., MD 130A-D) and input/output devices (e.g., I/O 140A-C). Each node 110A-C may be a computer, such as a physical machine and may include a device, such as hardware device. In an example, a hardware device may include a network device (e.g., a network adapter or any other component that connects a computer to a computer network), a peripheral component interconnect (PCI) device, storage devices, disk drives, sound or video adaptors, photo/video cameras, printer devices, keyboards, displays, etc. TEE instances 160A-B may be provisioned on the same host or node (e.g., node 110A) or different nodes. For example, TEE instance 160A and TEE instance 160B may both be provisioned on node 110A. Alternatively, TEE instance 160A may be provided on node 110A while TEE instance 160B is provisioned on node 110B.

As used herein, physical processor, processor or CPU 120A-D, refers to a device capable of executing instructions encoding arithmetic, logical, and/or I/O operations. In one illustrative example, a processor may follow Von Neumann architectural model and may include an arithmetic logic unit (ALU), a control unit, and a plurality of registers. In a further aspect, a processor may be a single core processor which is typically capable of executing one instruction at a time (or process a single pipeline of instructions), or a multi-core processor which may simultaneously execute multiple instructions. In another aspect, a processor may be implemented as a single integrated circuit, two or more integrated circuits, or may be a component of a multi-chip module (e.g., in which individual microprocessor dies are included in a single integrated circuit package and hence share a single socket). A processor may also be referred to as a central processing unit (CPU).

As discussed herein, a memory device 130A-D refers to a volatile or non-volatile memory device, such as RAM, ROM, EEPROM, or any other device capable of storing data. As discussed herein, I/O device 140A-C refers to a device capable of providing an interface between one or more processor pins and an external device capable of inputting and/or outputting binary data.

Processors (e.g., CPUs 120A-D) may be interconnected using a variety of techniques, ranging from a point-to-point processor interconnect, to a system area network, such as an Ethernet-based network. Local connections within each node, including the connections between a processor (e.g., CPU 120A-D) and a memory device 130A-D, may be provided by one or more local buses of suitable architecture, for example, peripheral component interconnect (PCI).

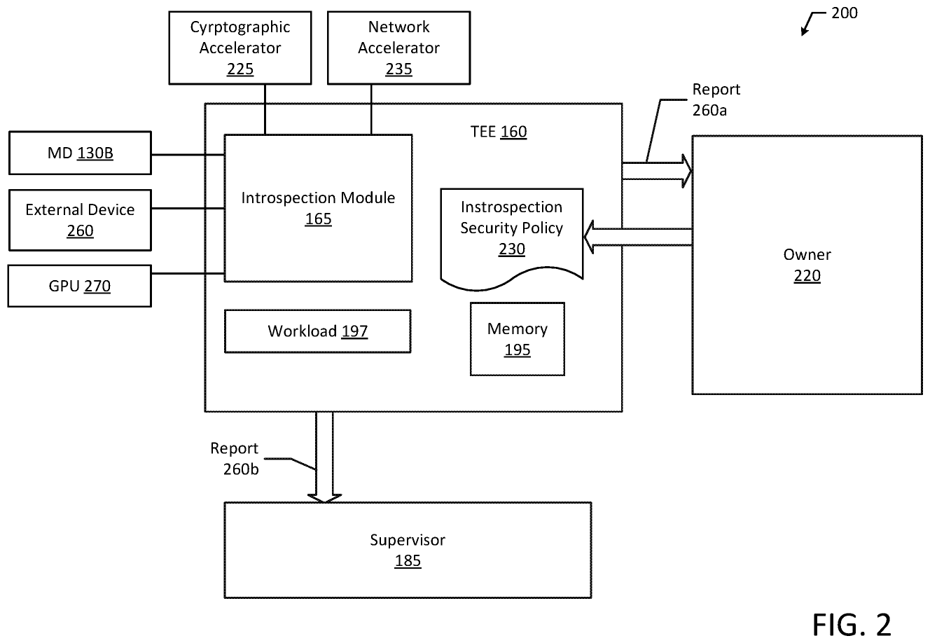

FIG. 2 illustrates a block diagram of an introspection system 200 for TEE instances. As illustrated in FIG. 2, a TEE or TEE instance 160 may execute a workload 197. The TEE 160 may include a memory 195 and an introspection module 165. Additionally, the TEE may include an introspection security policy 230 supplied by an owner 220. For example, owner 220 may supply the introspection security policy 230 to the TEE 160. In another example, the owner may also supply the introspection module 165, service, or program to the TEE 160. The introspection security policy 230 may be provided via an encrypted connection between owner 220 and TEE 160. Communications between the owner 220 and the TEE 160 may utilize a Secure Sockets Layer (“SSL”) and may be controlled through cryptographically secured keys or tokens. Encrypted data may be communicated from the owner 220 to the TEE 160 or the introspection module 165 where it is then decrypted by the receiver. The encryption and decryption may utilizing hashing functions such as the Secure Hash Algorithm (“SHA”) (e.g., SHA-128, SHA-256, etc.) or other hashing functions such as MDS. For example, the encrypted communications, secrets, tokens or keys may appear to be a random string of numbers and letters (e.g., 140RA9T426ED494E01R019). Additionally, the encryption and decryption processes may be performed according to the Advanced Encryption Standard (“AES”). AES is based on a design principle known as a substitution-permutation network, and may utilize keys with a key size of 128, 192, or 256 bits.

The introspection module 165 may be provided as code, such as bytecode. The bytecode may be WebAssembly (“WASM”) bytecode or Berekely Packet Filter (“BPF”) bytecode. In another example, the introspection module 165 may be provided as native code such as native client (“NaCl”) code. The workload 197 may include an executable, which may include instructions or commands that form all or part of the workload 197. Similarly, the introspection module 165 may include an executable, which may include instructions or commands that form all or part of the introspection module 165. The workload 197 and the introspection module 165 may also include a configuration file(s), a data set(s), and annotation tracks. In an example, the introspection module 165 may execute the instructions of the executable and monitor the memory access patterns that occur while the executable is running.

The owner 220 may be an owner of the workload 197 or an owner of the TEE 160 (e.g., container). The owner of the workload 197 or TEE 160 performs introspection services on the workload 197 to ensure that the workload 197 is safe without allowing the host (e.g., cloud service provider) to “look inside” the TEE 160 or workload 197. Furthermore, the cloud service provider allows the owner 220 to perform introspection services for the assurance that the TEE 160 will execute safe operations on the cloud, and more specifically that the workload 197 will not execute malicious or compromised code. By performing introspection services on the workload 197 according to the introspection security policy 230, the owner 220 may provide proof to the cloud service provider or the host that the TEE 160 and workload 197 will execute properly on the cloud.

During introspection, the introspection module 165 may execute or perform introspection commands on workload 197. The introspection module 165 may execute or perform the introspection commands according to the introspection security policy 230. For example, the introspection security policy 230 may provide a framework or guidelines of the portions of memory the introspection module is able to analyze. The introspection security policy 230 may hide or protect confidential information stored in certain portions of memory or may limit introspection to portions of memory that have dynamically loaded information. For example, static memory or static information may be ignored for operational reasons (e.g., static memory that is write-protected may pose an insignificant risk to the host or cloud service provider). Other portions of memory, such as the portion that stores the introspection module 165, may be hidden (e.g., not exposed) to the introspection services as the introspection service may be viewed as a compromised or malicious executable, similar to a virus scanner. Specifically, the introspection security policy 230 may specify what portion(s) of the TEE (e.g., what portions of memory 195 of the TEE 160) are exposed to the introspection module 165. Additionally, the introspection security policy 230 may specify which accelerator(s) (e.g., cryptographic accelerator 225 or network accelerator 235) or other devices (e.g., memory device 130B, external device 260, and graphics processing unit 270).

In one example, the memory 195 of the TEE 160 may be split into ten different regions. The introspection security policy 230 may specify that a first region is available for introspection, a second region is available for introspection and only visible to the host, a third region is available for introspection and only visible to a tenant, a fourth and fifth region are available for introspection and visible to both the host and the tenant, and the sixth through the tenth region are not available for introspection.

Once compromised, wasteful or malicious activity is detected (e.g., a compromised or malicious memory access pattern is identified), the TEE 160 or the introspection module 165 may generate a report (e.g., report 260a or 260b) summarizing the results from the introspection service. Reports of successful or passing introspection results may also be generated to indicate that the workload 197 and the TEE 160 is operating safely. A report 260a may be provided to the owner 220 and remedial action may take place. Additionally, a report 260b may be provided to the supervisor 185. In an example, the owner 220 or the supervisor 185 may request that the TEE 160 pause or stop execution.

The cryptographic accelerator 225 may be configured to perform cryptographic operations. The cryptographic accelerator 225 may be is a co-processor designed specifically to perform computationally intensive cryptographic operations, doing so far more efficiently than a general-purpose CPU. In an example, the workload 197 may include executing various cryptographic operations, executing cryptographic instructions, or accessing encrypted memory. Therefore, accessing and using the cryptographic accelerator 225 by the introspection module 165 may increase performance while performing introspection services.

A network accelerator may increase the speed of information flow between modules, devices or end users. In an example, the network accelerator may perform various network acceleration techniques such as traffic shaping, data deduplication and data caching, choice of protocols or protocol spoofing, and network monitoring. Traffic shaping may involve assigning priority to network traffic based on bandwidth allocation. Data deduplication and data caching may involve caching duplicate data and sending references to the cached data for additional requests of the same data, which reduces the data volume for remote backups, replication, and disaster recovery. By choosing specific protocols, high performance protocols, which are designed to provide high-bandwidth even in impaired networks, may be selected to enable low overhead transmissions and forward error correction. Protocol spoofing groups small, related protocols into a single protocol. Additionally, network monitoring detects non-essential traffic and re-routes that traffic or handles that traffic at more ideal times.

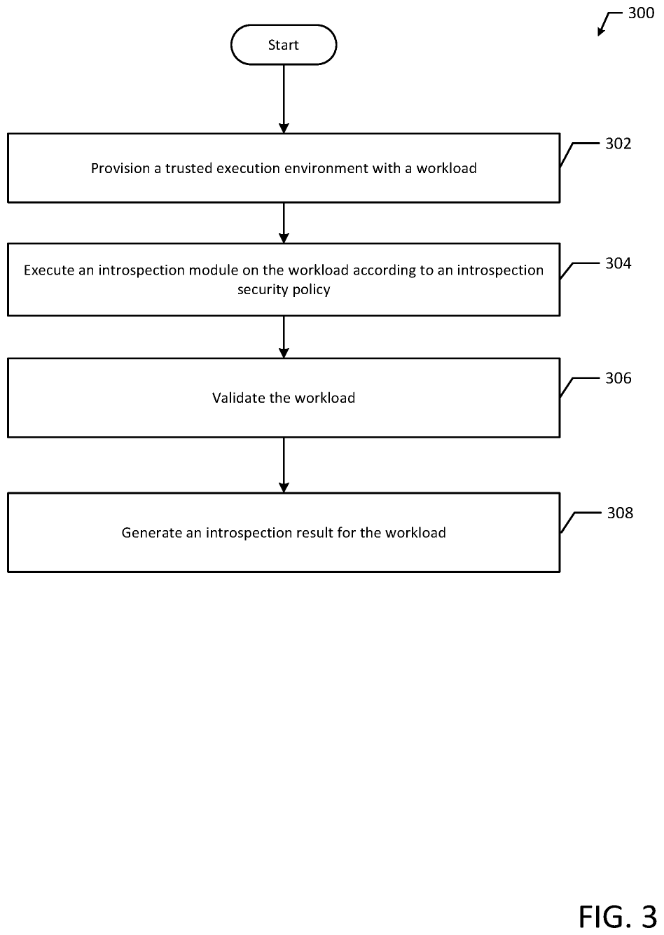

FIG. 3 illustrates a flowchart of an example method 300 for performing introspection for TEE instances in accordance with an example of the present disclosure. Although the example method 300 is described with reference to the flowchart illustrated in FIG. 3, it will be appreciated that many other methods of performing the acts associated with the method 300 may be used. For example, the order of some of the blocks may be changed, certain blocks may be combined with other blocks, blocks may be repeated, and some of the blocks described are optional. The method 300 may be performed by processing logic that may comprise hardware (circuitry, dedicated logic, etc.), software, or a combination of both.

In the illustrated example, method 300 includes provisioning a TEE with a workload (block 302). For example, a TEE 160 may be provisioned with a workload 197. The TEE 160 may include an introspection module (e.g., introspection module 165A, hereinafter referred to generally as introspection module 165). It should be appreciated that the TEE 160 may be a TEE instance, similar to the TEE 160 illustrated in FIG. 2. For example, TEE 160 of FIG. 2 may represent one of the TEE instance(s) 160A-B of FIG. 1, which may each be referred to generally as TEE 160. Method 300 also includes executing an introspection module on the workload according to an introspection security policy (block 304). For example, the introspection module 165 may be executed on the workload 197. In an example, execution may include executing an introspection command(s) on the workload 197 according to the introspection security policy 230. The introspection command(s) may be configured to validate the workload 197, such as one or more memory accesses associated with the workload 197. The introspection security policy 230 may specify what portion(s) of the TEE 160, such as memory 195, that is exposed to the introspection module 165. Additionally, the introspection security policy 230 may specify an accelerator(s) and/or device(s) that the introspection module 165 has access to. For example, the introspection module 165 may access an accelerator to improve speed and performance while performing introspection services on the workload 197. Additionally, the introspection module 165 may be granted access to other devices that the workload 197 may be accessing during execution. The introspection security policy 230 along with the introspection module 165 may be provided by an owner 220 (e.g., workload owner or TEE owner).

By loading the introspection security policy 230 from the owner 220, and using the introspection security policy 230 to limit the introspection of the workload 197, untrusted introspection programs (e.g., programs or instructions from introspection module 165) may run with access to private TEEs 160 without granting the introspection module 165 full access to the private TEEs 160, thereby advantageously preserving privacy and security.

As discussed above, the introspection security policy 230 may specify which parts of the TEE 160 are exposed to the introspection commands or the introspection module 165. For example, the introspection security policy 230 may dictate what portions of memory are reviewed for introspection purposes. In some cases, memory associated with high-risk workflows or workloads 197 may be exposed to the introspection module 165. Similarly, memory that dynamically changes may be exposed to the introspection module 165. In other cases, portions of memory that have shown vulnerabilities in the past may be exposed to the introspection module 165.

The introspection security policy 230 may specify a memory range or specific addresses the introspection module 165 has access to, and in some cases the introspection security policy 230 may grant read access to these addresses or portion of memory. For example, the introspection module 165 may be restricted to read access or read-only access in the event the TEE 160 becomes a malicious TEE 160 thereby preventing the associated workload 197, applications 198 or other components from performing additional malicious acts. In another example, the TEE 160 may be stopped from unnecessarily executing commands and storing data when wasteful memory access patterns are detected. For example, the TEE 160 may be paused or stopped instead of needlessly looping through instructions, such as repeatedly trying to obtain a lock or repeatedly trying and failing to update a table. Stopping the TEE 160 from performing these wasteful activities may advantageously conserve computing and memory resources.

Also, as noted above, the introspection security policy 230 may identify connectors or accelerators the introspection module 165 has access to. Connectors and accelerators may assist with generating rules and data objects necessary for the introspection module 165 or other applications of the TEE 210 to send messages or make requests of external systems. The connectors and accelerators may also assist with processing the results or responses to the messages or requests. In some examples, the connectors and accelerators may parse files, import metadata through introspection, connect to and analyze external databases, etc. The accelerator may also convert the resulting information into a specific class, property, and activity and determine the requisite connector rules to build the connector.

Then, method 300 includes validating the workload (block 306). For example, the introspection module 165 may validate the workload 197 by determining a status of a result of the introspection command(s) executed on the workload 197. In an example, the introspection command(s) may include an instruction to compare a memory access or a group of memory accesses to the predetermined pattern(s). The predetermined pattern may be a pattern of memory reads from memory or a specific memory location. For example, a specific pattern or sequence of memory accesses may indicate compromised, unauthorized or malicious activity by the TEE 160. In another example, the predetermined pattern may be a pattern of memory writes to the memory or a specific memory location. Other example patterns include a pattern or sequence of URLs visited by the workload 197, files accessed by the workload 197, messages sent by the workload 197, etc. In other example, the predetermined pattern may be related to types of data read from the memory and types of data written to the memory.

Additionally, the method 300 includes generating an introspection result for the workload (block 308). For example, the introspection module 165 may generate an introspection result for the workload 197. The introspection result may be a passing result or a failing result. Additionally, the introspection result may be associated with a result of a single introspection command or the result of executing multiple introspection commands. In another example, the TEE instance 160 or another component of the TEE instance 160 may determine and generate the introspection result obtained from executing the introspection command(s) on the workload 197. Any of the patterns mentioned above may indicate compromised, unauthorized or malicious activity and may result in a failing result after executing the introspection command(s).

A failure or failing result may indicate that the one or more memory accesses matches a predetermined pattern, which may be a previously identified pattern of malicious activity or a pattern indicating unnecessary and wasteful use of memory and computing resources. In an example, the introspection module 165 may compare the memory accesses to various predetermined patterns stored in an introspection log. A passing result may indicate that the workload 197 executed as expected without performing any unauthorized, compromised, or malicious operations. For example, a passing result may indicate that the workload 197 is safe to run on the TEE 160 in the cloud.

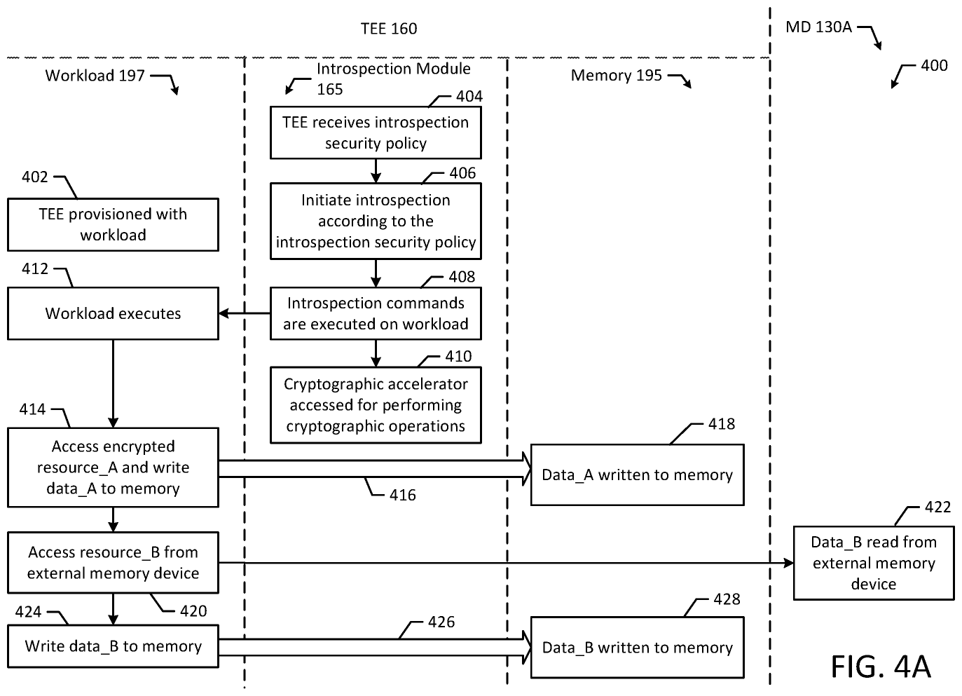

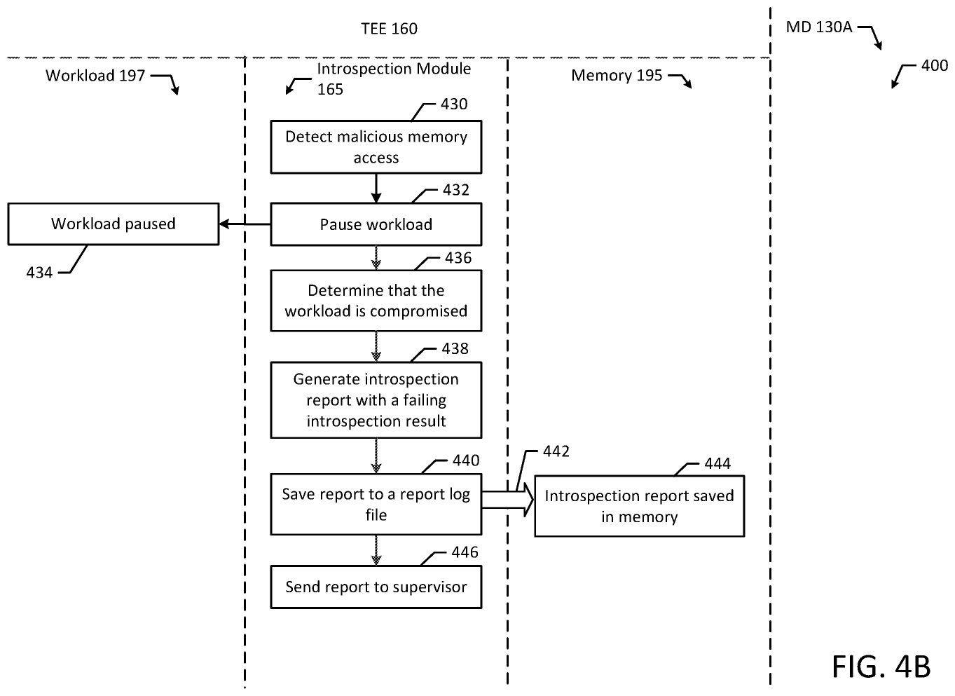

FIGS. 4A and 4B depicts a flow diagram illustrating an example method 400 for performing introspection services for a TEE while preserving privacy according to an example embodiment of the present disclosure. Although the example method 400 is described with reference to the flow diagram illustrated in FIGS. 4A and 4B, it will be appreciated that many other methods of performing the acts associated with the method may be used. For example, the order of some of the blocks may be changed, certain blocks may be combined with other blocks, blocks may be repeated, and some of the blocks described are optional. The method may be performed by processing logic that may comprise (e.g., circuity, dedicated logic, etc.), software, or a combination of both. For example, a TEE 160 executing a workload 197 may communicate with memory 195 and a memory device 130A to perform example method 400.

In the illustrated example, a TEE 160 is provisioned with a workload 197 (block 402). The workload may be include various operations, tasks and instructions performed by the TEE 160 or its associated applications 198. Additionally, the TEE 160 and more specifically an introspection module 165 receives an introspection security policy 230 (block 404). The introspection security policy 230 may specify (i) what portions of memory (e.g., memory 195 and MD 130A) the introspection module 165 has access to, (ii) what other devices (e.g., MD 130A and cryptographic accelerator 225) the introspection module 165 has access to, and (iii) what specific reporting guidelines the introspection module 165 should adhere to. Then, the introspection module initiates introspection (e.g., introspection services) according to the introspection policy 230 (block 406). As mentioned above, the introspection policy 230 may limit the introspection services to certain portions of memory, devices, etc. The introspection module 165 executes introspection commands on the workload 197 (block 408). As noted above, the workload 197 may include various operations, tasks and instructions performed by the TEE 160 or its associated applications 198, which may be performed along with the introspection commands to detect if the workload 197 is compromised. While executing the introspection command, the introspection module 165 accesses a cryptographic accelerator 225 for performing cryptographic operations (block 410). For example, the introspection module 165 may access the cryptographic accelerator 225 to perform computationally intensive cryptographic operations, such as executing cryptographic instructions, or accessing encrypted memory. Additionally, the workload 197 executes (block 412) while the introspection services are carried out. Specifically, the introspection services may track and extract security-relevant information from the executing workload 197 to determine if the workload 197 or TEE 160 is compromised.

During execution, the workload 197 accesses encrypted resource_A and writes data 416 from the resource (e.g., data_A) to memory 195 (block 414). In an example, the cryptographic accelerator 225 may assist in obtaining and writing the encrypted data 416 to the memory 195. Then the data 416 (e.g., data_A) is written to memory 195 (block 418). Similarly, the workload 197 accesses resource_B from an external memory device 130A (block 420). For example, the introspection security policy 230 may allow the introspection module 165 to track and monitor activity (e.g., perform introspection services) associated with external memory device 130A. During workload execution, data_B is read from the external memory device (block 422). Similar to the memory 195, the introspection services may track and extract security-relevant information from the executing workload 197 to determine if the workload 197 or TEE 160 is compromised. After accessing resource_B, the workload 197 writes the data 426 (e.g., data_B) to memory 195 (block 424). Then, the data 426 (e.g., data_B) is written to memory 195 (block 428). In the illustrated example, the TEE 160 may provide memory management functions and services and when visiting a memory location, the TEE 160 may write to memory 195 the data from the visited memory location.

Then, the TEE 160 and more specifically, the introspection module 165 detects a malicious memory access (block 430). For example, accessing resource_B and writing the data 426 (e.g., data_B) into memory 195 may be predefined as a compromised or malicious memory event. In an example, each act of writing the data 426 to memory may be intercepted and analyzed by the introspection module 165 to determine if that access is part of a malicious pattern or event. Then, the introspection module 165 pauses the workload 197 (block 432). Now, the workload is paused (block 434). For example, the workload 197 may be paused as soon as a compromised or malicious memory event is detected to prevent further malicious activity or damage to the system. In other examples, the introspection module 165 may continue executing the workload 197 and performing introspection services to detect and log other malicious or compromised memory activity.

The introspection module 165 may further analyze the workload 197 and the previous introspection commands and determine that the workload 197 is compromised (block 436). For example, the introspection module 165 may analyze the extracted security-relevant information from executing the workload 197. The extracted information may be compared to a memory detection pattern. The memory detection patterns may include a specific sequence of accessing specific resources. In another example, the memory detection pattern may be a pattern or a series of events involving writing certain data to memory or writing data to a specific memory location. Alternatively, the pattern may indicate a sequence of unnecessary activity resulting in unnecessary memory usage and wasting computing resources.

After determining that the workload 197 is compromised, the introspection module generates an introspection report that indicates a failing introspection result (block 438). In an example, the workload 197 may customarily prepare a log file, such as an application log, that documents activities performed by the workload 197. For example, the application log may include a log of memory writes from a CPU to RAM and may also include the introspection report and any associated introspection results. The introspection module 165 saves the report 442 to a report log file (block 440). The introspection report may log each compromised malicious memory event (e.g., memory access, memory read, memory write, etc.). In some examples, the introspection report or the log may be analyzed and reviewed to determine other potential malicious memory access patterns that can be used to detect future compromised or malicious activity. Then, the introspection report 442 is saved in the memory 195 (block 444). In the illustrated example, the introspection module 165 sends the report 442 to a supervisor 185. For example, once the report 442 is generated, the report 442 may be passed along to the supervisor 185, such as a hypervisor 180, or to an owner 220 to take corrective action. In another example, the report 442 may be passed along to the supervisor 185, hypervisor 180 or owner 220 after a threshold amount of compromised or malicious activity is detected (e.g., after three possible malicious memory access patterns are detected).

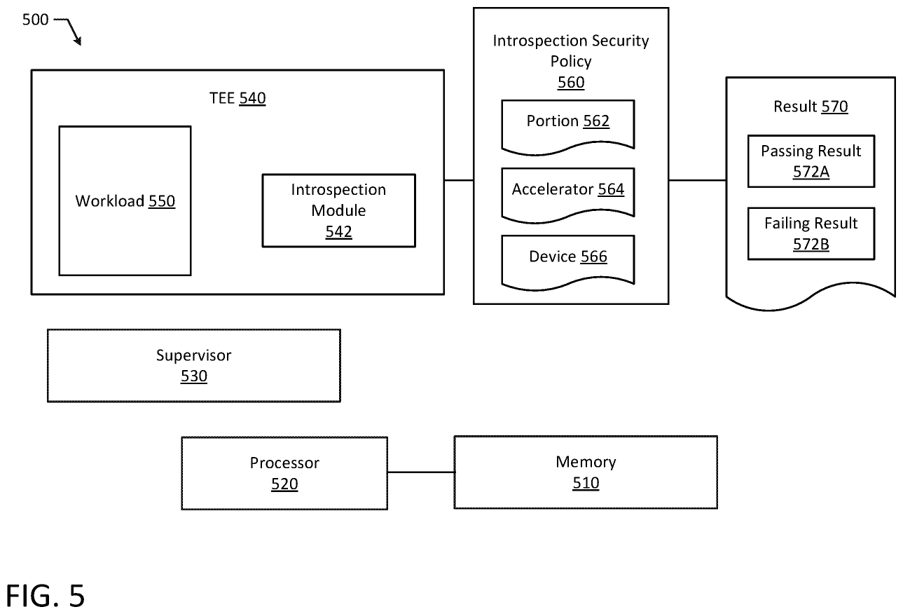

FIG. 5 is a block diagram of an example introspection system 500 for TEEs according to an example of the present disclosure. The introspection system 500 may preserve privacy between a supervisor or host administrator and a TEE (e.g., container) while performing introspection services. The introspection system 600 includes a memory 510, a processor 520 in communication with the memory 510, a supervisor 530, and a trusted execution environment 540. The TEE 540 includes an introspection module 542 and is configured to execute the introspection module 542 on a workload 550 according to an introspection security policy 560. Additionally, the TEE 540 is configured to generate an introspection result 570 for the workload 550. The introspection security policy 560 specifies at least one of (i) a portion 562 of the TEE 540 that is exposed to the introspection module 542 and (ii) at least one of an accelerator 564 and a device 566 the introspection module 542 has access to. Additionally, the introspection module 542 is configured to validate the workload 550. The introspection result 570 may be either a passing result 572A or a failing result 572B.

The introspection module 542 advantageously allows the TEE 540 to perform introspection services, which would otherwise be provided as part of a supervisor 530. However, the security model of a TEE 540 typically does not allow trusting the supervisor 530 with access to the memory of the TEE 540. For example, the introspection capabilities of the supervisor 530 may allow a host administrator full access to and full inspection of the TEE 540, without any privacy constraints afforded to the owner of the TEE 540 or workload 550. By providing the introspection module 542 subject to the introspection security policy 560, which is supplied by the owner of the TEE 540 or workload 550, the supervisor 530 can enforce the security policy for the introspection and the TEE 540 can consume the introspection services provided by the introspection module 542 without fully trusting the supervisor 530. Specifically, the introspection security policy 560 preserves privacy between the supervisor 530 or host administrator and the TEE 540 (e.g., container) while performing introspection services. The introspection services provided by the introspection module 542 may determine if the TEE 540 or the workload 550 are compromised, such that action may be taken to prevent further malicious or compromised activity that causes harm to the system 500.

It will be appreciated that all of the disclosed methods and procedures described herein can be implemented using one or more computer programs or components. These components may be provided as a series of computer instructions on any conventional computer readable medium or machine-readable medium, including volatile or non-volatile memory, such as RAM, ROM, flash memory, magnetic or optical disks, optical memory, or other storage media. The instructions may be provided as software or firmware, and/or may be implemented in whole or in part in hardware components such as ASICs, FPGAs, DSPs or any other similar devices. The instructions may be configured to be executed by one or more processors, which when executing the series of computer instructions, performs or facilitates the performance of all or part of the disclosed methods and procedures.

It should be understood that various changes and modifications to the example embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A system comprising:
a memory;
a processor in communication with the memory;
a supervisor; and
a trusted execution environment (TEE), wherein the TEE includes an introspection module, the TEE configured to:
execute the introspection module on a workload according to an introspection security policy, and
generate an introspection result for the workload, wherein
the introspection security policy specifies at least one of (i) a portion of the TEE that is exposed to the introspection module and (ii) at least one of an accelerator and a device the introspection module has access to, and
the introspection module is configured to validate the workload, wherein the introspection result is one of a passing result and a failing result.

2. The system of claim 1, wherein the failing result indicates that the workload is a compromised workload.

3. The system of claim 2, wherein the compromised workload attempts to perform at least one memory access that matches a predetermined malicious pattern.

4. The system of claim 3, wherein the introspection module includes an instruction to compare the at least one memory access to the predetermined malicious pattern.

5. The system of claim 1, wherein the TEE is an encrypted virtual machine.

6. The system of claim 1, wherein the portion of the TEE that is exposed to the introspection module includes an address of the TEE that the introspection module has access to.

7. The system of claim 1, wherein the portion of the TEE is a first portion of memory associated with the TEE, and wherein the introspection security policy is configured to restrict access to a second portion of memory associated with the TEE.

8. The system of claim 1, wherein the accelerator is one of a cryptographic accelerator configured to perform cryptographic operations and a network accelerator configured to increase a speed of information flow between the introspection module and a host, and wherein the device is one of a memory device and a graphics processing unit.

9. The system of claim 1, wherein the introspection module is configured to process the introspection result and generate an introspection report, and wherein the introspection module is configured to send the introspection report to a host, wherein the host is a cloud service provider.

10. The system of claim 1, wherein the supervisor is a hypervisor.

11. A method comprising:
provisioning a trusted execution environment (TEE) with a workload, wherein the TEE includes an introspection module;
executing the introspection module on the workload according to an introspection security policy, wherein the introspection security policy specifies at least one of (i) a portion of the TEE that is exposed to the introspection module and (ii) at least one of an accelerator and a device the introspection module has access to;
validating the workload; and
generating an introspection result for the workload, wherein the introspection result is one of a passing result and a failing result.

12. The method of claim 11, wherein the failing result indicates that the workload is a compromised workload.

13. The method of claim 12, further comprising comparing at least one memory access by the workload to a predetermined malicious pattern.

14. The method of claim 11, wherein the portion of the TEE that is exposed to the introspection module includes an address of the TEE that the introspection module has access to.

15. The method of claim 11, wherein the portion of the TEE is a first portion of memory associated with the TEE, the method comprising granting read access to the first portion of memory and restricting access to a second portion of memory associated with the TEE.

16. The method of claim 11, wherein the first portion of memory includes dynamically loaded information, and wherein the second portion of the memory includes at least one of (a) confidential information and (b) unchanged static information.

17. The method of claim 11, further comprising:
processing the introspection result to generate an introspection report; and
sending the introspection report to a host.

18. The method of claim 17, wherein the host is a cloud service provider, and wherein the host sends an instruction to the TEE based on the report.

19. The method of claim 17, wherein the introspection security policy further specifies a reporting guideline for the introspection module, and the introspection module sends the introspection result directly to the host through an application programming interface (API) according to the reporting guideline.

20. A non-transitory machine-readable medium storing code, which when executed by at least one processor is configured to:
provision a trusted execution environment (TEE) with a workload, wherein the TEE includes an introspection module;
execute the introspection module on the workload according to an introspection security policy, wherein the introspection security policy specifies at least one of (i) a portion of the TEE that is exposed to the introspection module and (ii) at least one of an accelerator and a device the introspection module has access to;
validate the workload; and
generate an introspection result for the workload, wherein the introspection result is one of a passing result and a failing result.
